(19) United States
(12) Patent Application Publication
(10) Pub. No.: US 2026/0330254 A1
(43) Pub. Date: Oct. 22, 2026

(54) SLOPE STABILITY PREDICTION METHOD AND APPARATUS, DEVICE, MEDIUM AND PRODUCT

(71) Applicant: Southwest University of Science and Technology, Mianyang City (CN)

(72) Inventors: Dengfeng Su, Mianyang City (CN); Baohui Tan, Mianyang City (CN); Li Zhao, Mianyang City (CN); Yingpeng Hu, Mianyang City (CN); Kun Li, Mianyang City (CN); Qiang Zhu, Mianyang City (CN); Telin Zeng, Mianyang City (CN); Rongkai Chen, Mianyang City (CN); Rui Wang, Mianyang City (CN); Xingming Chen, Mianyang City (CN)

(21) Appl. No.: 19/468,067

(22) Filed: Feb. 3, 2026

(30) Foreign Application Priority Data
Mar. 27, 2025 (CN) 202510373266.9

(51) Int. Cl. G06N 5/022

(52) U.S. Cl. CPC G06N 5/022

(57) ABSTRACT

Provided are a slope stability prediction method and apparatus, a device, a medium and a product, which belong to the field of slope stability prediction. The slope stability prediction method includes: acquiring mine slope stability influencing factors; performing prediction with a multilayer perceptron (MLP) prediction model and an extreme gradient boosting (XGBoost) prediction model according to the mine slope stability influencing factors to obtain an MLP predicted value and an XGBoost predicted value, the MLP prediction model and the XGBoost prediction model being optimized with a Tent variational sparrow search algorithm (Tent-VSSA); and performing weighted fusion based on a weight of a fusion model according to the MLP predicted value, the XGBoost predicted value and a true value to obtain a slope stability. This application improves the operability and accuracy for stability prediction.

### CROSS REFERENCE TO RELATED APPLICATION

This patent application claims the benefit and priority of Chinese Patent Application No. 202510373266.9, filed with the China National Intellectual Property Administration on Mar. 27, 2025, the disclosure of which is incorporated by reference herein in its entirety as part of the present application.

### TECHNICAL FIELD

The present disclosure relates to the field of slope stability prediction, and in particular to a slope stability prediction method and apparatus, a device, a medium and a product.

### BACKGROUND

Conventional methods research the slope stability through field investigation, laboratory test, numerical computation and the like based on the engineering geology and rock mechanics. In modern times, there are limit equilibrium methods, graphical methods, numerical analysis methods, kinematical element methods, theoretical applications of unsaturated soil strengths, machine learning algorithms, etc. Particularly, with the development of computer technologies, in order to predict the slope stability intelligently and timely, increasingly more scholars employ the machine learning algorithms to address this nonlinear problem. The conventional methods have the low accuracy in spite of practicability and operability, while the modern methods have the high cost and high technical requirements in spite of high accuracy. Therefore, a method capable of improving the accuracy without compromising the operability is desired.

### SUMMARY

An objective of the present disclosure is to provide a slope stability prediction method and apparatus, a device, a medium and a product. The present disclosure can improve the operability and accuracy in stability prediction.

To achieve the above objective, the present disclosure provides the following solutions:

According to a first aspect, the present disclosure provides a slope stability prediction method, including:
acquiring mine slope stability influencing factors;
performing prediction with a multilayer perceptron (MLP) prediction model and an extreme gradient boosting (XGBoost) prediction model according to the mine slope stability influencing factors to obtain an MLP predicted value and an XGBoost predicted value, the MLP prediction model and the XGBoost prediction model being optimized with a Tent variational sparrow search algorithm (Tent-VSSA);
performing weighted fusion based on a weight of a fusion model according to the MLP predicted value, the XGBoost predicted value and a true value to obtain a slope stability;
determining whether the slope stability exceeds a predetermined threshold; and
sending a warning signal indicating an instability state of a slope to an external device in response to a determination that the slope stability exceeds the predetermined threshold.

Optionally, the mine slope stability influencing factors specifically include: a slope angle, a unit weight, a cohesion, a pore pressure coefficient, an internal friction angle and a slope height.

Optionally, the MLP prediction model is specifically determined as follows:
constructing an original MLP model and initializing a weight and a bias of the original MLP model; and
optimizing an initialized weight and an initialized bias of the original MLP model with the Tent-VSSA according to sample data to obtain the MLP prediction model, the sample data being true mine slope stability influencing factors and corresponding true slope stabilities.

Optionally, the XGBoost prediction model is specifically determined as follows:
constructing an original XGBoost model and determining an objective function of the original XGBoost model;
solving the objective function with a simplified Taylor expansion equation and a decision tree, and determining hyperparameters of the original XGBoost model; and
optimizing the hyperparameters of the original XGBoost model with the Tent-VSSA according to sample data to obtain the XGBoost prediction model, the sample data being true mine slope stability influencing factors and corresponding true slope stabilities.

Optionally, the weight of the fusion model is specifically determined as follows:
performing prediction with the MLP prediction model according to true mine slope stability influencing factors to obtain a first predicted value;
performing prediction with the XGBoost prediction model according to the true mine slope stability influencing factors to obtain a second predicted value; and
determining the weight of the fusion model with an error reciprocal method according to the first predicted value, the second predicted value and a true slope stability.

Optionally, Cauchy mutation perturbation is used to perform fused mutation on the Tent-VSSA.

According to a second aspect, the present disclosure provides a slope stability prediction apparatus, including a processor and a memory storing program codes, wherein the processor performs the stored program codes to:
acquire mine slope stability influencing factors;
perform prediction with an MLP prediction model and an XGBoost prediction model according to the mine slope stability influencing factors to obtain an MLP predicted value and an XGBoost predicted value, the MLP prediction model and the XGBoost prediction model being optimized with a Tent-VSSA; and
perform weighted fusion based on a weight of a fusion model according to the MLP predicted value, the XGBoost predicted value and a true value to obtain a slope stability;
determine whether the slope stability exceeds a predetermined threshold; and
send a signal indicating an instability state of a slope to external devices in response to the stability monitoring module determining that the slope stability exceeds the predetermined threshold.

According to a third aspect, the present disclosure provides a computer device, including: a memory, a processor, and a computer program stored in the memory and executable on the processor, where the processor executes the computer program to implement the slope stability prediction method.

According to fourth aspect, the present disclosure provides a computer-readable storage medium, where the computer-readable storage medium stores a computer program, and the computer program implements the slope stability prediction method when executed by a processor.

According to fifth aspect, the present disclosure provides a computer program product, including a computer program, where the computer program implements the slope stability prediction method when executed by a processor.

According to specific embodiments provided in the present disclosure, the present disclosure has the following technical effects:

According to the slope stability prediction method and apparatus, the device, the medium and the product provided by the present disclosure, prediction is performed with an MLP prediction model and an XGBoost prediction model according to a distribution of mine slope stability influencing factors. Parameters in the MLP prediction model and the XGBoost prediction model are optimized through a Tent-VSSA. With the Tent-VSSA for adaptively optimizing the parameters in the models, the present disclosure reduces the iteration count of the algorithm, and improves the optimization efficiency and prediction accuracy of the models. By predicting two predicted values with the mine slope stability influencing factors, and performing weighted fusion on the two predicted values, the present disclosure further improves the operability and accuracy for stability prediction.

### BRIEF DESCRIPTION OF THE DRAWINGS

To describe the technical solutions in the embodiments of the present disclosure or in the prior art more clearly, the following briefly describes the accompanying drawings required for the embodiments. Apparently, the accompanying drawings in the following description show merely some embodiments of the present disclosure, and those of ordinary skill in the art may still derive other accompanying drawings from these accompanying drawings without creative efforts.

FIG. 1 illustrates an application scenario of a slope stability prediction method according to an embodiment of the present disclosure;

FIG. 2 illustrates a schematic flowchart of a slope stability prediction method according to an embodiment of the present disclosure;

FIG. 3 illustrates iterations of each of a Tent-VSSA, an SSA and a grey wolf optimizer (GWO) for searching an objective function value according to an embodiment of the present disclosure;

FIG. 4 illustrates time of each of a Tent-VSSA, an SSA and a GWO for searching an objective function value according to an embodiment of the present disclosure;

FIG. 5 illustrates optimal objective function values searched by a Tent-VSSA, an SSA and a GWO according to an embodiment of the present disclosure;

FIG. 6 illustrates a flowchart of a Tent-VSSA-MLP model according to an embodiment of the present disclosure;

FIG. 7 illustrates a flowchart of a Tent-VSSA-XGBoost model according to an embodiment of the present disclosure;

FIG. 8 is a schematic diagram of a slope stability prediction method according to an embodiment of the present disclosure;

FIG. 9 is a schematic block diagram of a slope stability prediction method according to an embodiment of the present disclosure;

FIG. 10 illustrates stability predicted results after data are imported according to an embodiment of the present disclosure; and

FIG. 11 is a schematic structural diagram of a computer device according to an embodiment of the present disclosure.

### DETAILED DESCRIPTION OF THE EMBODIMENTS

The technical solutions in the embodiments of the present disclosure are clearly and completely described below with reference to the drawings in the embodiments of the present disclosure. Apparently, the described embodiments are only some rather than all of the embodiments of the present disclosure. All other embodiments obtained by those of ordinary skill in the art based on the embodiments of the utility model without creative efforts shall fall within the protection scope of the utility model.

At present, the research on slope stability is focused mainly on dynamic response and rainfall infiltration of the slope, but rarely on sensitivities of slope stability influencing factors. Actually, there are numerous influencing factors on the slope stability. To determine relative importance of these influencing factors and prioritize research directions are critical to research the slope stability. The influencing factors on the slope stability are roughly classified into two types, including engineering geological characteristics, such as a rock type, a joint surface condition, a cohesion, and a geostress, and meteorological and hydrological characteristics, such as a rainfall, a rainfall intensity, underground water, and a saturation rate of soil. Geographic and geomorphologic characteristics include a slope height, a slope angle, and a slope shape. Other factors include an earthquake, a rock and soil weathering degree, and a slope protection situation. These sensitive factors should be prioritized, but not treated equally during the survey and design. To analyze and research these factors, some subjective research methods are often adopted, and the methods are relatively single, or only a single working condition is analyzed. As a result, in actual engineering application, the result obtained by some method is deviated greatly from the actual situation. Therefore, in the present disclosure, an original MLP prediction model and an original XGBoost prediction model are constructed. A weight and a bias of the original MLP prediction model and hyperparameters of the original XGBoost prediction model are adaptively optimized through a Tent-VSSA. A mean square error (MSE) of a training set of an optimized model is obtained. A weight of a fusion model is determined with an error reciprocal method. A final slope stability is determined with the weight of the fusion model according to two well-trained prediction models. By performing prediction with the constructed models according to various mine slope stability influencing factors, and performing weighted fusion on predicted values, the present disclosure reduces the deviation caused by the single influencing factor, further improving accuracy of prediction. The present disclosure can reduce the iteration count of the algorithm, shorten the calculation time, and accurately predict the stability of the slope, providing a reference value for the slope stability prediction.

To make the above objectives, features, and advantages of the present disclosure more obvious and easy to understand, the present disclosure will be further described in detail with reference to the accompanying drawings and specific implementations.

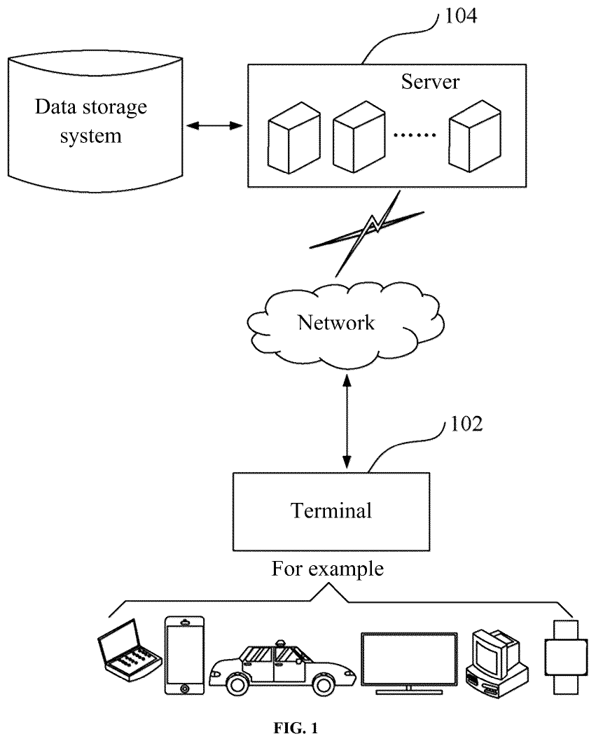

An embodiment of the present disclosure provides a slope stability prediction method, which may be applied to an application scenario shown in FIG. 1. A terminal 102 communicates with a server 104 through a network. A data storage system may store data to be processed by the server 104. The data storage system may be provided independently, may also be integrated to the server 104, and may further be provided on a cloud or other servers. The terminal 102 may send mine slope stability influencing factors to the server 104. After the server 104 receives the mine slope stability influencing factors, for the mine slope stability influencing factors, the server 104 performs prediction with an MLP prediction model and an XGBoost prediction model according to the mine slope stability influencing factors to obtain an MLP predicted value and an XGBoost predicted value. The MLP prediction model and the XGBoost prediction model are optimized with a Tent-VSSA. The server 104 performs weighted fusion based on a weight of a fusion model according to the MLP predicted value, the XGBoost predicted value and a true value to obtain a slope stability. The server 104 may feed the slope stability back to the terminal 102. In addition, in some embodiments, the slope stability prediction method may also be implemented by the server 104 or the terminal 102 alone. For example, the terminal 102 may directly predict the slope stability according to the mine slope stability influencing factors. The server 104 may also acquire the mine slope stability influencing factors from the data storage system, and predicts the slope stability according to the mine slope stability influencing factors.

The terminal 102 may be, but is not limited to, various desktop computers, laptops, smartphones, tablets, Internet of things (IoT) devices and portable wearable devices. The IoT devices may include a smart speaker, a smart television, a smart air conditioner, a smart vehicle-mounted device, etc. The portable wearable devices may include a smartwatch, a smart bracelet, a headset device, etc. The server 104 may be a standalone server or a server cluster consisting of multiple servers, and may also be a cloud server.

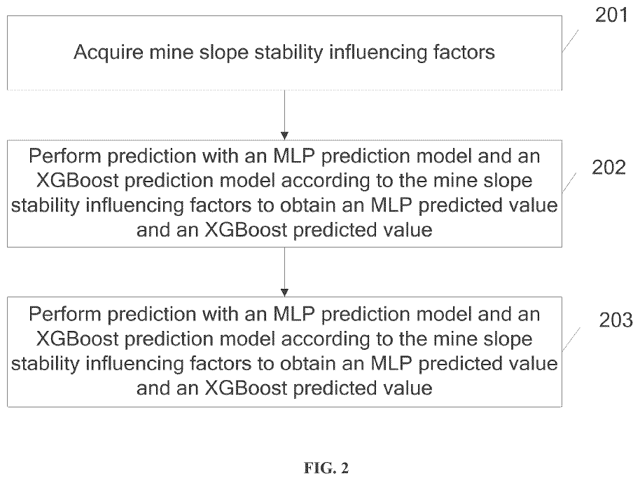

In an exemplary embodiment, as shown in FIG. 2, a slope stability prediction method is provided. The method is executed by a computer device. Specifically, the method may be executed by a terminal or a server alone, and may also be executed by the terminal and the server jointly. In the embodiment of the present disclosure, a case where the method is applied to the server 104 in FIG. 1 is used as an example for description. The method includes the following steps 201-203. Specifically:

Step 201: Mine slope stability influencing factors are acquired.

Step 202: Prediction is performed with an MLP prediction model and an XGBoost prediction model according to the mine slope stability influencing factors to obtain an MLP predicted value and an XGBoost predicted value.

Step 203: Weighted fusion is performed based on a weight of a fusion model according to the MLP predicted value, the XGBoost predicted value and a true value to obtain a slope stability.

By implementing the above steps 201 to 203, the operability and accuracy for stability prediction are improved.

In an exemplary embodiment of the present disclosure, the mine slope stability influencing factors specifically include: a slope angle, a unit weight, a cohesion, a pore pressure coefficient, an internal friction angle and a slope height.

In an exemplary embodiment of the present disclosure, the MLP prediction model is specifically determined as follows:

An original MLP model is constructed and a weight and a bias of the original MLP model are initialized.

An initialized weight and an initialized bias of the original MLP model are optimized with the Tent-VSSA according to sample data to obtain the MLP prediction model, the sample data being true mine slope stability influencing factors and corresponding true slope stabilities.

In an exemplary embodiment of the present disclosure, the XGBoost prediction model is specifically determined as follows:

An original XGBoost model is constructed and an objective function of the original XGBoost model is determined.

The objective function is solved with a simplified Taylor expansion equation and a decision tree, and hyperparameters of the original XGBoost model are determined.

The hyperparameters of the original XGBoost model are optimized with the Tent-VSSA according to sample data to obtain the XGBoost prediction model, the sample data being true mine slope stability influencing factors and corresponding true slope stabilities.

In an exemplary embodiment of the present disclosure, the weight of the fusion model is specifically determined as follows:

Prediction is performed with the MLP prediction model according to true mine slope stability influencing factors to obtain a first predicted value.

Prediction is performed with the XGBoost prediction model according to the true mine slope stability influencing factors to obtain a second predicted value.

The weight of the fusion model is determined with an error reciprocal method according to the first predicted value, the second predicted value and a true slope stability.

In an exemplary embodiment of the present disclosure, Cauchy mutation perturbation is used to perform fused mutation on the Tent-VSSA.

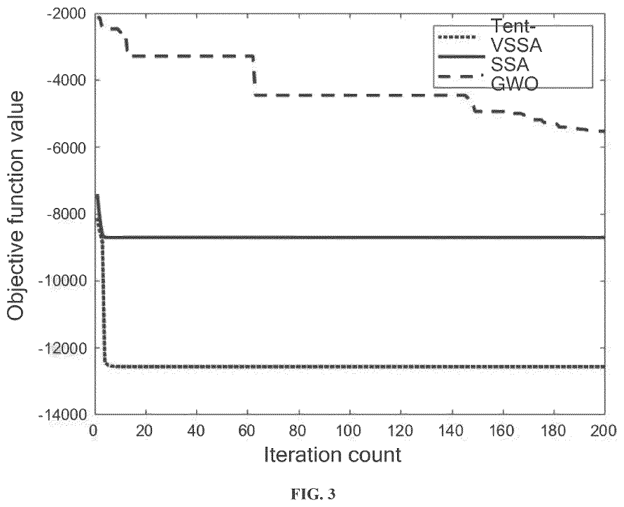

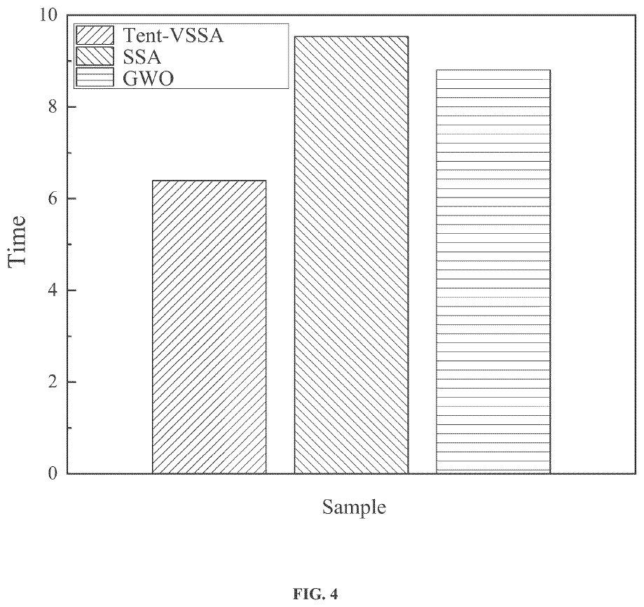

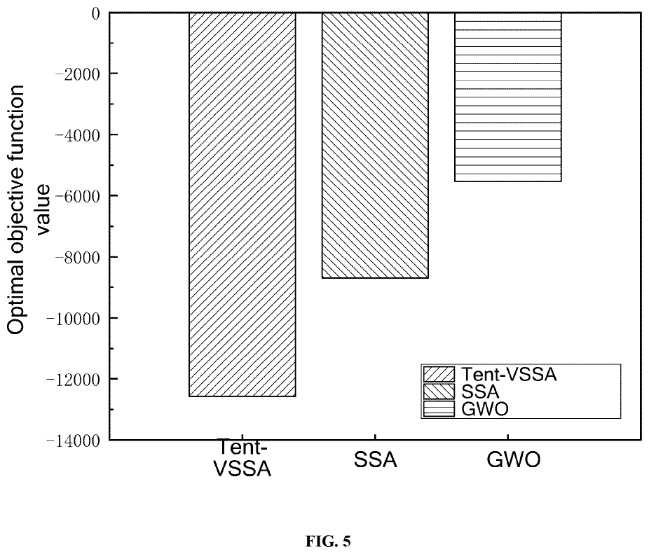

The present disclosure adaptively optimizes the weight and the bias of the MLP model and the hyperparameters of the XGBoost model in combination with the intelligent optimization algorithm Tent-VSSA, and is successfully applied to slope stability prediction, reducing the iteration count of the algorithm, and improving optimization efficiency and prediction accuracy of the models. FIG. 3 illustrates comparison on optimization curves of the Tent-VSSA, the SSA and the GWO for objective function values, in which the Tent-VSSA declines faster and has higher efficiency. FIG. 4 illustrates comparison on optimization time required by the Tent-VSSA, the SSA and the GWO algorithm, in which the Tent-VSSA is faster. FIG. 5 illustrates optimal objective function values found by the Tent-VSSA, the SSA and the GWO algorithm, in which the value of the Tent-VSSA is smaller, namely more optimal. The finally determined model can accurately predict the stability of the slope. With overall consideration on multiple factors, the present disclosure can improve the accuracy for slope stability prediction.

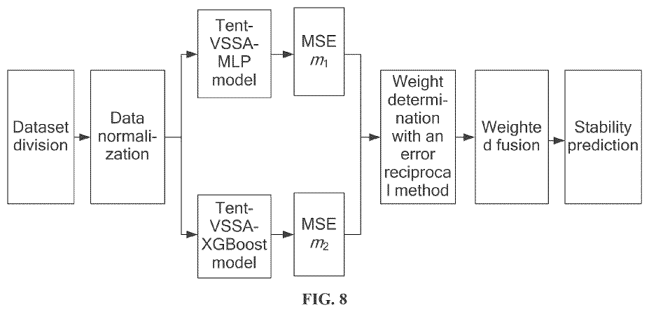

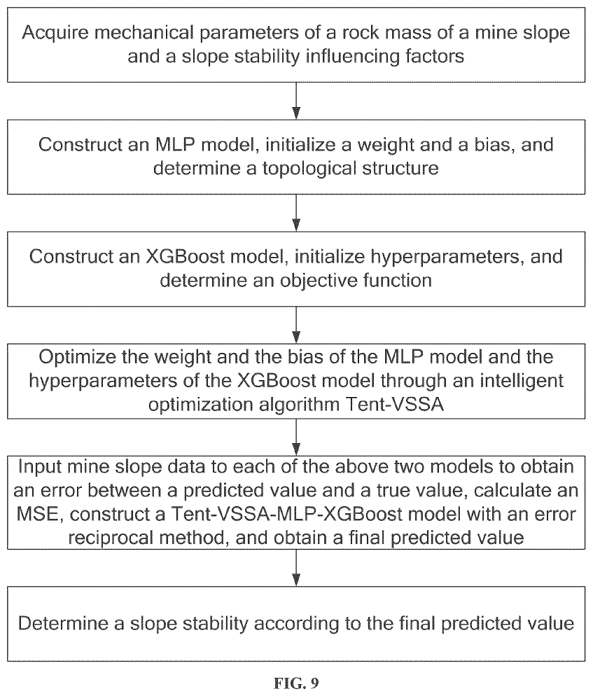

As shown in FIG. 8 and FIG. 9, in order to further demonstrate feasibility of the slope stability prediction method provided by the present disclosure, a specific process of the slope stability prediction method in actual application is further provided, including:

Mine slope stability influencing factors are acquired. Specifically, geological conditions, water, weathering and the like are factors to destroy the slope stability. When machine learning algorithms are used for prediction and research, rationality of influencing factors will have a direct impact on a predicted result. Parameters are selected according to three principles. Specifically, sensitive and stable parameters that reflect slope stability characteristics are taken as evaluation indexes. All parameters are physically independent of each other. The parameters are easily acquired or obtained. Based on the above reasons, according to weights of the slope stability influencing factors, six relevant parameters, including a slope angle (β), a unit weight (γ), a cohesion (c), a pore pressure coefficient (ru), an internal friction angle (φ) and a slope height (H), are selected. The slope angle (β) can be measured directly or indirectly using equipment such as the total station, level gauge, or laser rangefinder. The unit weight (γ) may be calculated by measuring the weight of a unit volume of rock or soil sample, often using weight sensors with methods like the cutting ring method and sand replacement method. The cohesion (c) and the internal friction angle (φ), which together characterize the shear strength, can be determined using a direct shear apparatus or a triaxial compression apparatus. The pore pressure coefficient (ru) can be measured with pressure monitoring devices such as the pressure gauge or the piezometric tube.

An MLP model is constructed, a weight and a bias are initialized, and a topological structure is determined. Specifically, a basic structure of an MLP network, an activation function between an input layer and a hidden layer and an activation function between the hidden layer and an output layer in forward propagation, and a back propagation method are determined.

The MLP is also called an artificial neural network (ANN). The most typical MLP includes three layers: the input layer, the hidden layer, and the output layer. The first layer is called the input layer, the last layer is called the output layer, and the intermediate layer is called the hidden layer. For the MLP, different layers are fully connected, there are no limits made on a number of hidden layers and a number of neurons on the output layer, and an appropriate number of hidden layers can be selected as required.

In the forward propagation, a sigmoid function is employed between the input layer and the hidden layer, and a tanh function is employed between the hidden layer and the output layer. The number of neurons on the hidden layer is determined by an empirical Eq. (1). The initialization is performed, until the forward propagation is completed. An error between a predicted value and an output value is calculated. Back propagation is performed with a gradient descent method to update a weight and a threshold, until a specified iteration count or a specified error is reached.

n₁=\sqrt{n+m}+a (1)
where, n₁ is the number of neurons on the hidden layer; n is a number of neurons on the input layer; m is a number of neurons on the output layer; and a is a regulating constant between 1 and 10.

An XGBoost model is constructed, hyperparameters are initialized, and an objective function is determined. Specifically, an objective function of the XGBoost model, a simplified Taylor expansion equation, construction of a tree and a complexity of the tree, and a solution of the objective function are determined.

### 1) Objective Function of the XGBoost Model

The algorithm is jointly determined by multiple associated classification and regression trees (CARTs) shown in Eq. (3). Therefore, a predicted result may be expressed as:

$${\hat{y}}_{i}^{( K )} = {\sum }_{k = 1}^{K} {f}_{k} ( {x}_{i} ) = {\hat{y}}_{i}^{( K - 1 )} + {f}_{K} ( {x}_{i} ) \qquad ( 2 )$$

where, K represents a number of trees, ƒₖ(xᵢ) is a predicted result of a k-th tree in an i-th sample, ŷᵢ^{(K)} is a predicted value jointly given by K trees in the sample xᵢ, ŷᵢ^{(K-1)} is a predicted value jointly given by K−1 trees in the sample xᵢ, and ƒ_{K}(xᵢ) is a predicted value of a K-th tree in the i-th sample.

The objective function of the XGBoost model includes a loss function and a regularization term. The loss function represents a deviation of the model, while the regularization term is used to prevent overfitting. The objective function obj(θ) is defined as follows:

$$obj ( θ ) = {\sum }_{i = 1}^{s} l ( {y}_{i} , {\hat{y}}_{i}^{( K )} ) + {\sum }_{k = 1}^{K} Ω ( {f}_{k} ) \qquad ( 3 )$$

where,

$${\sum }_{i = 1}^{n} l ( {y}_{i} , {\hat{y}}_{i}^{( K )} )$$

is the loss function;

$${\sum }_{k = 1}^{K} Ω ( {f}_{k} )$$

is to seek a sum of complexities of all K trees, and add the sum to the objective function to serve as the regularization term; S is a sample size; yᵢ is a true value of the sample xᵢ;

$${\hat{y}}_{i}^{( K )}$$

is the predicted value jointly given by the K trees in the sample xᵢ; and ƒₖ is the k-th tree.

### 2) Simplified Taylor Expansion Equation

Decision trees are associated with each other. From the perspective of model optimization, as shown in Eq. (4), a prediction error of the previous tree serves as a reference value for the next tree. For the top t trees (t≤K), the objective function of the sample xᵢ may be expressed as:

$${obj}^{( t )} ( θ ) = {\sum }_{i = 1}^{n} l ( {y}_{i} , {\hat{y}}_{i}^{( t )} ) + {\sum }_{k = 1}^{t} Ω ( {f}_{k} ) = {\sum }_{i = 1}^{n} l ( {y}_{i} , {\hat{y}}_{i}^{( t - 1 )} + {f}_{t} ( {x}_{i} ) ) + Ω ( {f}_{t} ) + C \qquad ( 4 )$$

where, since conditions of top t−1 trees are known,

$${\sum }_{k = 1}^{t - 1} Ω ( {f}_{k} )$$

is a constant C, and ŷᵢ^{(t)} is a predicted value given by a t-th tree in the sample xᵢ.

Through a two-order Taylor expansion equation:

$$f ( x + Δ x ) \approx f ( x ) + {f}^{′} ( x ) Δ x + \frac{{f}^{″} ( x )}{2} {( Δ x )}^{2} \qquad ( 5 )$$

where, by taking ƒₜ(xᵢ) as Δx, and

$${\hat{y}}_{i}^{( t - 1 )}$$

as x, ƒ′(x) is a primary derivative value of

$${\sum }_{i = 1}^{n} l ( {y}_{i} , {\hat{y}}_{i}^{( t - 1 )} ) + Ω ( {f}_{t} ) ,$$

and ƒ″(x) is a secondary derivative value,
simplifying the objective function obtains:

$${obj}^{( t )} ( θ ) = {\sum }_{i = 1}^{n} [ l ( {y}_{i} , {\hat{y}}_{i}^{( t - 1 )} ) + {g}_{i} \cdot {f}_{t} ( {x}_{i} ) + \frac{1}{2} {h}_{i} \cdot {f}_{t}^{2} ( {x}_{i} ) ] + Ω ( {f}_{t} ) + C \qquad ( 6 )$$

where,

$${g}_{i} = \frac{\partial l ( {y}_{i} , {\hat{y}}_{i}^{( t - 1 )} )}{{\partial }_{{\hat{y}}_{i}^{( t - 1 )}}}$$

represents a first-order derivative, and a known number that can be calculated;

$${h}_{i} = \frac{{\partial }^{2} l ( {y}_{i} , {\hat{y}}_{i}^{( t - 1 )} )}{{\partial }_{{\hat{y}}_{i}^{( t - 1 )}}^{2}}$$

represents a second-order derivative, and a known number that can be calculated; and

$$l ( {y}_{i} , {\hat{y}}_{i}^{( t - 1 )} )$$

is also a constant. Removing the constant is to minimize the objective function:

$${obj}^{( t )} ( θ ) = {\sum }_{i = 1}^{n} [ {g}_{i} \cdot {f}_{t} ( {x}_{i} ) + \frac{1}{2} {h}_{i} \cdot {f}_{t}^{2} ( {x}_{i} ) ] + Ω ( {f}_{t} ) \qquad ( 7 )$$

### 3) Construction of the Tree and Complexity of the Tree

The complexity of the tree may be represented by a number of leaf nodes and weights of the nodes. Meanwhile, each part is controlled by hyperparameters:

$$Ω ( {f}_{t} ) = α T + \frac{1}{2} λ {\sum }_{j = 1}^{T} {( {w}_{j} )}^{2} \qquad ( 8 )$$

where, T is a number of all leaf nodes; wⱼ is a weight of a j-th node; and α and λ are hyperparameters.

When one tree is defined, with W as a value of the leaf node, q(xᵢ) as a leaf node of the sample xᵢ, and Iⱼ as a sample set to which the j-th node belongs, the predicted value of the ƒₖ(xᵢ) may be represented with W_{q(x}_{ᵢ}₎ to obtain:

$${\sum }_{i = 1}^{n} [ {g}_{i} \cdot {f}_{t} ( {x}_{i} ) + \frac{1}{2} {h}_{i} \cdot {f}_{t}^{2} ( {x}_{i} ) ] + Ω ( {f}_{t} ) \qquad ( 9 )$$

$$= {\sum }_{i = 1}^{n} [ {g}_{i} \cdot {W}_{q ( {x}_{i} )} + \frac{1}{2} {h}_{i} \cdot {W}_{q ( {x}_{i} )}^{2} ] + α T + \frac{1}{2} λ {\sum }_{j = 1}^{T} {( {w}_{j} )}^{2}$$

$$= {\sum }_{j = 1}^{T} [ ( {\sum }_{i ∈ {I}_{j}} {g}_{i} ) {w}_{j} + \frac{1}{2} ( {\sum }_{i ∈ {I}_{j}} {h}_{i} + λ ) {w}_{j}^{2} ] + α T$$

### 4) Solution of the Objective Function

Defining Σ_{i∈I}_{ⱼ}gᵢ=Gⱼ and Σ_{i∈I}_{ⱼ}hᵢ=Hⱼ may obtain the objective function obj:

$$obj = {\sum }_{j = 1}^{T} [ {G}_{j} {w}_{j} + \frac{1}{2} ( {H}_{j} + λ ) {w}_{j}^{2} ] + α T \qquad ( 10 )$$

By changing the equation into a univariate quadratic function with respect to wⱼ. When

$${w}_{j} = - \frac{{G}_{j}}{( {H}_{j} + α )} ,$$

a minimum is obtained:

$$o b j = - \frac{1}{2} {\sum }_{j = 1}^{T} \frac{{G}_{j}^{2}}{( {H}_{j} + λ )} + α T \qquad ( 11 )$$

where, obj is the objective function value.

For the XGBoost model, a group of weak learners are constructed, and results of multiple decision trees are accumulated to serve as a final predicted output. This algorithm effectively combines the decision trees with the concept of integration, and involves in many hyperparameters. Setting of these hyperparameters has a direct impact on the prediction accuracy of the model. Herein, four influential parameters, including a number of initialized trees (n_estimators=100), a learning rate (learning_rate=0.1), a depth of the tree (max_depth=6), and a randomness (sub_sample=1), are mainly optimized.

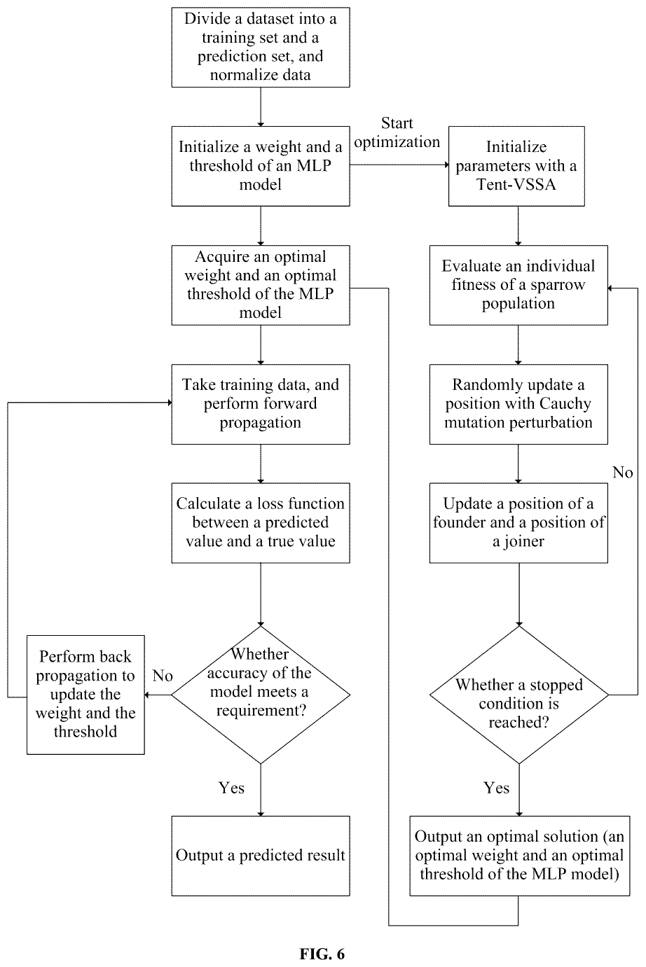

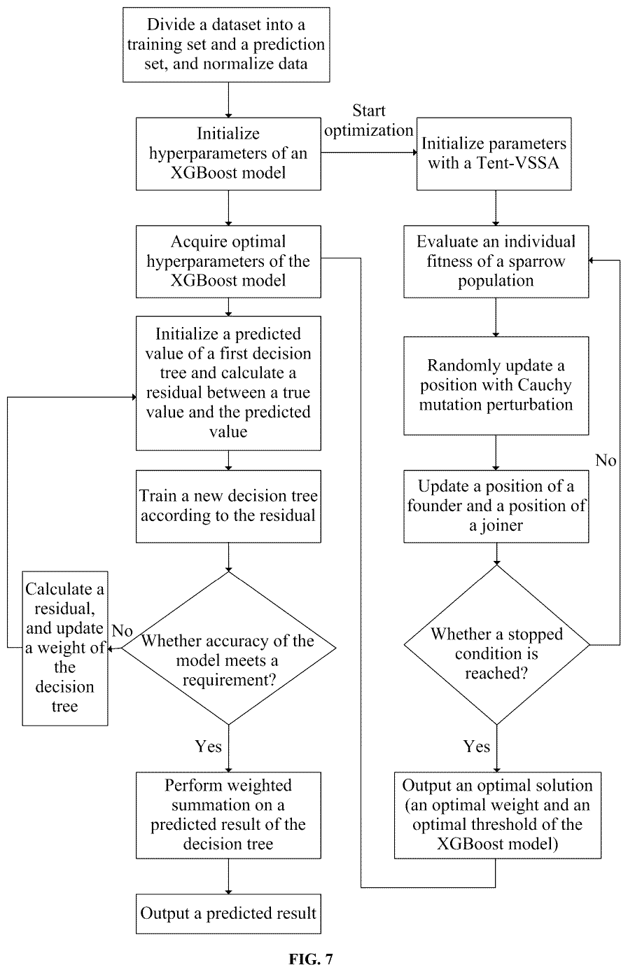

The weight and the bias of the MLP model and the hyperparameters of the XGBoost model are optimized through an intelligent optimization algorithm Tent-VSSA. As shown in FIG. 6 and FIG. 7, specifically: Data is normalized, and divided into training data and test data. Parameters such as a population size and a dimension are brought into a Tent initial population space, and a fitness value of each population in the space is calculated. Fused mutation is performed randomly with the Cauchy mutation perturbation strategy. A position of a founder is updated. A position of a joiner is updated. A sparrow population makes an anti-predation behavior when exhibiting danger perception. It is assumed that sparrows exhibiting the danger perception account for 30% of the total population. When a current iteration count reaches a maximum iteration count, a weight and a bias of the Tent-VSSA-MLP prediction model and hyperparameters of the Tent-VSSA-XGBoost prediction model are an optimal solution corresponding to a current generation.

1) Training data (80%) and predicted data (20%) are normalized by:

$${x}^{′} = \frac{x - min ( x )}{max ( x ) - min ( x )} \qquad ( 12 )$$

where, x is current sample data; x′ is a normalized value of the current sample data; min(x) is a minimum in the sample; and max(x) is a maximum in the sample.

A part of the data is shown in Table 1 after processed:

TABLE 1
Parameter table in stable state

| | Unit | | Internal | Slope | Slope | Pore water | |
|---|---|---|---|---|---|---|---|
| Serial | weight | Cohesion | friction | angle | height | pressure | Stable |
| No. | γ | c | angle φ | α | H | coefficient rᵤ | state |
| 1 | 0.408 | 0.088 | 0.584 | 0.218 | 0.011 | 0.587 | 1 |
| 2 | 0.311 | 0.00 | 0.414 | 0.00 | 0.007 | 0.717 | 0 |
| 3 | 0.351 | 0.00 | 0.433 | 0.069 | 0.121 | 0.761 | 0 |
| . | . | . | . | . | . | . | . |
| 1119 | 0.750 | 0.283 | 0.8 | 0.842 | 0.847 | 0.326 | 1 |
| 1120 | 0.295 | 0.066 | 0.686 | 0.422 | 0.033 | 0.022 | 0 |

2) Parameters such as a population size and a dimension are brought into a Tent initial population space by:

$${x}_{n + 1} = \{ \begin{matrix}μ {x}_{n} , 0 \leq {x}_{n} < \frac{1}{2} \\ μ ( 1 - {x}_{n} ) , \frac{1}{2} \leq {x}_{n} \leq 1\end{matrix} \qquad ( 13 )$$

where, xₙ is a generated random value between 0 and 1, xₙ₊₁ is an output population space, and μ is an influencing value of a chaos coefficient on the output population space.

Associated parameters (including the population size: 100, and the maximum iteration count: 50) are brought into the Tent initial population space and a fitness value of the initial population is calculated. The weight and the bias of the MLP model, and the hyperparameters of the XGBoost model are selected as the fitness value. In each iteration, for the sparrow population in the previous iteration, fitness values of nests are calculated and sorted in an ascending manner. According to the fitness values, top 20% of sparrows are classified as founders, and remaining 80% of sparrows are classified as joiners.

3) Fused mutation is performed randomly with the Cauchy mutation perturbation strategy, or a position for executing the original algorithm is updated. The Cauchy perturbation equation is expressed as:

X_{new}=X_{best}+X_{best}×cauch(0,θ) (14)
where, X_{new} is a new position upon the Cauchy mutation perturbation, X_{best} represents a central optimal position, and cauch (0, θ) represents a Cauchy random distribution number with a mean being 0 and a scale parameter being θ. With the mutation perturbation strategy, the algorithm can jump out of a locally optimal solution, enhancing the global searching ability.

4) A position of a founder is updated.

$${X}_{i , j}^{t + 1} = \{ \begin{matrix}{X}_{i , j}^{t} \cdot exp ( \frac{- i}{α \cdot {iter}_{ma x}} ) & , {R}_{2} < {S}_{T} \\ {X}_{i , j}^{t} + Q \cdot L & , {R}_{2} \geq {S}_{T}\end{matrix} \qquad ( 15 )$$

where, X_{i,j}^{t} is j-dimension positional information of an i-th sparrow in a t-th iteration;

$${X}_{i , j}^{t + 1}$$

is j-dimension positional information of an i-th sparrow in a (t+1)-th iteration; α∈(0,1] is a random number; R₂∈[0,1] is a random number; S_{T}∈[0.5,1] is a constant; when a warning value R₂<a safety value S_{T}, a current environment is safe, allowing the founder to search extensively; when the warning value R₂>the safety value S_{T}, there is a predator, and all sparrows need to relocate to a safe area; iterₘₐₓ is a maximum iteration count; Q is a random number following a normal distribution; and L is a 1×d matrix in which all elements are 1.

5) A position of a joiner is updated.

$${X}_{i , j}^{t + 1} = \{ \begin{matrix}Q \cdot exp ( \frac{{X}_{worst}^{t} - {X}_{i , j}^{t}}{{i}^{2}} ) & , i > \frac{n}{2} \\ {X}_{P}^{t + 1} + \vert {X}_{i , j}^{t} - {X}_{p}^{t + 1} \vert \cdot {A}^{+} \cdot L & , i \leq \frac{n}{2}\end{matrix} \qquad ( 16 )$$

where, X_{P} is an optimal position held by the founder; X_{worst} represents a current global worst position; and A represents a 1×d matrix, in which each element is randomly assigned with either 1 or −1, A⁺ is a Moore-Penrose inverse matrix of the matrix A, and represents that the A⁺ is calculated when AA^{T} is invertible, and A⁺=A^{T}(AA^{T})⁻¹. When

$$i > \frac{n}{2} ,$$

an i-th joiner has a lower fitness value and is in a highly hungry state. It must relocate to another area for foraging to replenish its energy.

6) A sparrow population makes an anti-predation behavior when exhibiting danger perception. It is assumed that sparrows exhibiting the danger perception account for 30% of the total population.

$${X}_{i , j}^{t + 1} = \{ \begin{matrix}{X}_{best}^{t} + β \cdot \vert {X}_{i , j}^{t} - {X}_{best}^{t} \vert & , {f}_{i} > {f}_{g} \\ {X}_{i , j}^{t} + L \cdot ( \frac{\vert {X}_{i , j}^{t} - {X}_{worst}^{t} \vert}{( {f}_{i} - {f}_{w} ) + ε} ) & , {f}_{i} = {f}_{g}\end{matrix} \qquad ( 17 )$$

where, X_{best} is a current global optimal position; β is a step size control parameter, and is a random number following an N (0, 1) normal distribution; L∈[−1, 1] is a random number; and ƒᵢ is a fitness value of a current sparrow, ƒ_{y} and ƒ_{w} are respectively a current global best fitness value and a current global worst fitness value, and E is a constant to prevent division by zero. When ƒᵢ>ƒ_{y}, the sparrow is at the population boundary. X_{best} represents a central position, around which the sparrow is safe. When ƒᵢ>ƒ_{y}, the sparrow in the center of the population exhibits the danger perception, and needs to get close to other sparrows. K represents a relocation direction of the sparrow, and is also the step size control coefficient.

7) When a current iteration count reaches a maximum iteration count, a weight and a bias of the Tent-VSSA-MLP prediction model and hyperparameters of the Tent-VSSA-XGBoost prediction model are an optimal solution corresponding to a current generation.

Mine slope data is input to each of the above two models to obtain an error between the predicted value and the true value, thereby computing an MSE. Through the error reciprocal method, a Tent-VSSA-MLP-XGBoost model is constructed to obtain a final predicted value. Specifically, an MSE between the predicted value and the true value of the Tent-VSSA-MLP model is calculated. An MSE between the predicted value and the true value of the Tent-VSSA-XGBoost model is calculated. Through the error of each model, a weight of the model is calculated. Weights of all models are normalized. Weighted fusion is performed on predicted results of the models with normalized weights to obtain the final predicted value.

1) An MSE between the predicted value and the true value of the Tent-VSSA-HLP model on the training set and an MSE between the predicted value and the true value of the Tent-VSSA-XGBoost model on the training set are calculated, and labeled as m₁ and m₂.

$$MSE = \frac{{\sum }_{i = 1}^{p} {( {y}_{i} - {\hat{y}}_{i} )}^{2}}{p} \qquad ( 18 )$$

where, p is a number of training sets of each model; yᵢ is the true value; and ŷᵢ is the predicted value.

2) According to the error of each model, a weight of the model is calculated by:

$${ω}_{i} = \frac{1}{{m}_{i}} \qquad ( 19 )$$

where, ωᵢ is the weight, and mᵢ is the error.

3) Weights of all models are normalized, such that a sum of all weights is 1, and labeled as:

$${ω}_{i}^{′} = \frac{{ω}_{i}}{{\sum }_{j = 1}^{n} {ω}_{j}} \qquad ( 20 )$$

where, ωⱼ is a weight of a j-th sample.

4) Weighted fusion:

$${f}_{t} = {ω}_{1}^{′} {f}_{1 t} + {ω}_{2}^{′} {f}_{2 t} , t = 1 , 2 , … n \qquad ( 21 )$$

where, ƒ₁ₜ is the predicted value of the Tent-VSSA-MLP model; ƒ₂ₜ is the predicted value of the Tent-VSSA-XGBoost model; ƒₜ is the final predicted value;

$${ω}_{1}^{′}$$

is the weight of the ƒ₁ₜ; and

$${ω}_{2}^{′}$$

is the weight of the ƒ₂ₜ.

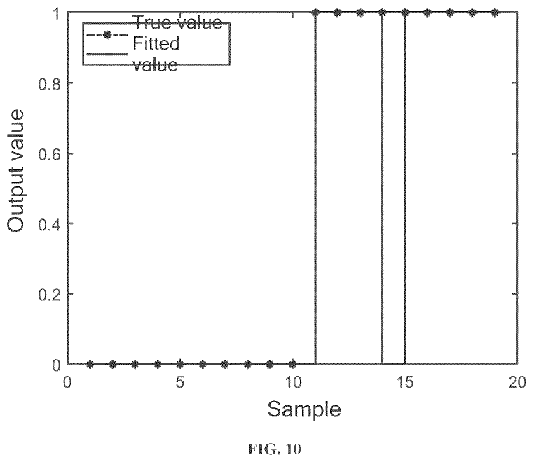

The slope stability is determined according to the final predicted value. As shown in FIG. 10, the output fitted value and the true value are in good agreement, and thus the slope stability can be predicted accurately.

In some embodiments, a predetermined threshold for slope stability is set based on prior data. When the slope stability is below the predetermined threshold, the slope is determined to be in a stable state, no warning signal is sent. In this case, the process continues to acquire mine slope stability influencing factors and calculate the stability result based on the acquired factors. When the slope stability exceeds the predetermined threshold, the slope is determined to be in an unstable state. The system can send a signal that carries warning information or is converted into warning information to external devices to transmit warning information to the user. For example, the term “warning information” can be pre-set text messages such as “Caution: slope instability”, or sound and light alarms, such as turning on warning lights or sounding an alarm through speakers. In some implementations, external devices may be mobile communication equipment such as mobile phones, tablets, personal computers, etc., and/or acoustic and/or optical alarms such as warning lights, buzzers, and speakers.

The present disclosure constructs the MLP model and the XGBoost model, optimizes the weight and the bias of the MLP model and four hyperparameters of the XGBoost model through the intelligent optimization algorithm Tent-VSSA, and performs the weighted fusion. The Tent-VSSA-MLP-XGBoost based slope stability prediction method can overcome the problems of accuracy and overfitting of the single algorithm in slope stability prediction, with the more scientific and reasonable prediction process, and the more accurate predicted result.

Based on a same inventive concept, an embodiment of the present disclosure further provides a slope stability prediction apparatus for implementing the slope stability prediction method. Implementation solutions provided by the apparatus to solve the problems are the same as implementation solutions described in the method. Hence, specific limitations in one or more embodiments of the slope stability prediction apparatus may be referenced to the foregoing limitations on the slope stability prediction method, and are not repeated herein.

In an exemplary embodiment, a slope stability prediction apparatus is provided, including: an acquisition module, a prediction module, and a weighted fusion module.

The acquisition module is configured to acquire mine slope stability influencing factors.

The prediction module is configured to perform prediction with an MLP prediction model and an XGBoost prediction model according to the mine slope stability influencing factors to obtain an MLP predicted value and an XGBoost predicted value, the MLP prediction model and the XGBoost prediction model being optimized with a Tent-VSSA.

The weighted fusion module is configured to perform weighted fusion based on a weight of a fusion model according to the MLP predicted value, the XGBoost predicted value and a true value to obtain a slope stability.

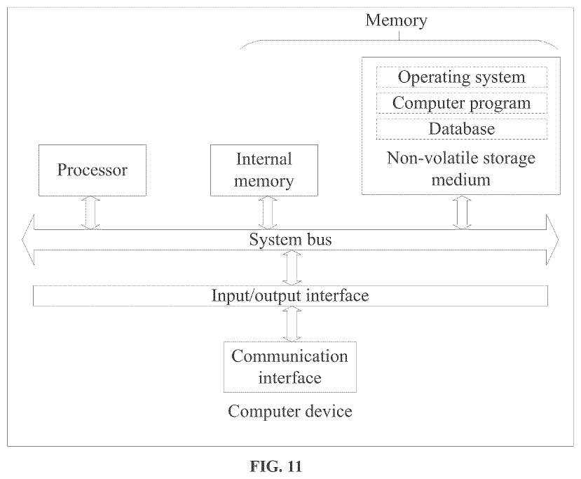

In an exemplary embodiment, a computer device is provided. The computer device may be a server or a terminal, and an internal structure thereof may be as shown in FIG. 11. The computer device includes a processor, a memory, an input/output (I/O) interface and a communication interface. The processor, the memory and the I/O interface are connected through a system bus. The communication interface is connected to the system bus through the I/O interface. The processor of the computer device is configured to provide computing and control capabilities. The memory of the computer device includes a nonvolatile storage medium and an internal memory. The nonvolatile storage medium stores an operating system, a computer program, and a database. The internal memory provides an environment for operation of the operating system and the computer program in the nonvolatile storage medium. The database of the computer device is configured to store slope stability data. The input/output interface of the computer device is configured to exchange information between the processor and an external apparatus. The communication interface of the computer device is configured to communicate with an external terminal through a network. The computer program implements the slope stability prediction method when executed by the processor.

Those skilled in the art may understand that the structure shown in FIG. 11 is only a block diagram of a part of the structure related to the solutions of the present disclosure and does not constitute a limitation on the computer device to which the solutions of the present disclosure are applied. Specifically, the computer device may include more or less components than those shown in the figure, or combine some components, or have different component arrangements. In an exemplary embodiment, a computer device is provided, including a memory and a processor. The memory stores a computer program. The computer program is executed by the processor to implement the above method embodiment.

In an exemplary embodiment, a computer-readable storage medium is provided. The computer-readable storage medium stores a computer program, and the computer program implements the above method embodiment when executed by a processor.

In an exemplary embodiment, a computer program product is provided. The computer program product stores a computer program. The computer program implements the above method embodiment when executed by a processor.

It is to be noted that information of a user (including but not limited to device information of the user, personal information of the user and the like) and data (including but not limited to data for analysis, data for storage, data for exhibition and the like) in the present disclosure are information and data authorized by the user or fully authorized by each party, and relevant data shall be acquired, used and processed according to relevant regulations.

Those of ordinary skill in the art may understand that all or some of the procedures in the method of the foregoing embodiments may be implemented by a computer program instructing related hardware. The computer program may be stored in a nonvolatile computer-readable storage medium. When the computer program is executed, the procedures in the embodiments of the foregoing method may be performed. Any reference to a memory, a database, or other media used in the embodiments of the present application may include a non-volatile and/or volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. As an illustration rather than a limitation, the RAM may be in various forms, such as a static random access memory (SRAM) or a dynamic random access memory (DRAM).

The database in the embodiments of the present disclosure may include at least one of a relational database and a non-relational database. The non-relational database may include a distributed database based on a blockchain, but is not limited thereto. The processor in the embodiments of the present disclosure may be a general processor, a central processor, a graphics processor, a digital signal processor (DSP), a programmable logic device, and a data processing logic device based on quantum computing, but is not limited thereto.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

Several examples are used herein for illustration of the principles and implementations of the present disclosure. The description of the foregoing examples is used to help illustrate the method of the present disclosure and the core principles thereof. In addition, those of ordinary skill in the art can make various modifications in terms of specific implementations and scope of application in accordance with the teachings of the present disclosure. In conclusion, the content of the present specification shall not be construed as a limitation to the present disclosure.

What is claimed is:

1. A computer implemented method for slope stability prediction, comprising:
acquiring mine slope stability influencing factors;
performing prediction with a multilayer perceptron (MLP) prediction model and an extreme gradient boosting (XGBoost) prediction model according to the mine slope stability influencing factors to obtain an MLP predicted value and an XGBoost predicted value, the MLP prediction model and the XGBoost prediction model being optimized with a Tent variational sparrow search algorithm (Tent-VSSA);
performing weighted fusion based on a weight of a fusion model according to the MLP predicted value, the XGBoost predicted value and a true value to obtain a slope stability;
determining whether the slope stability exceeds a predetermined threshold; and
sending a warning signal indicating an instability state of a slope to an external device in response to a determination that the slope stability exceeds the predetermined threshold.

2. The slope stability prediction method according to claim 1, wherein the mine slope stability influencing factors specifically comprise: a slope angle, a unit weight, a cohesion, a pore pressure coefficient, an internal friction angle and a slope height.

3. The slope stability prediction method according to claim 1, wherein the MLP prediction model is specifically determined as follows:
constructing an original MLP model and initializing a weight and a bias of the original MLP model; and
optimizing an initialized weight and an initialized bias of the original MLP model with the Tent-VSSA according to sample data to obtain the MLP prediction model, the sample data being true mine slope stability influencing factors and corresponding true slope stabilities.

4. The slope stability prediction method according to claim 1, wherein the XGBoost prediction model is specifically determined as follows:
constructing an original XGBoost model and determining an objective function of the original XGBoost model;
solving the objective function with a simplified Taylor expansion equation and a decision tree, and determining hyperparameters of the original XGBoost model; and
optimizing the hyperparameters of the original XGBoost model with the Tent-VSSA according to sample data to obtain the XGBoost prediction model, the sample data being true mine slope stability influencing factors and corresponding true slope stabilities.

5. The slope stability prediction method according to claim 1, wherein the weight of the fusion model is specifically determined as follows:
performing prediction with the MLP prediction model according to true mine slope stability influencing factors to obtain a first predicted value;
performing prediction with the XGBoost prediction model according to the true mine slope stability influencing factors to obtain a second predicted value; and
determining the weight of the fusion model with an error reciprocal method according to the first predicted value, the second predicted value and a true slope stability.

6. The slope stability prediction method according to claim 1, wherein Cauchy mutation perturbation is used to perform fused mutation on the Tent-VSSA.

7. A slope stability prediction apparatus, comprising comprises a processor and a memory storing program codes, wherein the processor performs the stored program codes to:
acquire mine slope stability influencing factors;
perform prediction with a multilayer perceptron (MLP) prediction model and an extreme gradient boosting (XGBoost) prediction model according to the mine slope stability influencing factors to obtain an MLP predicted value and an XGBoost predicted value, the MLP prediction model and the XGBoost prediction model being optimized with a Tent variational sparrow search algorithm (Tent-VSSA);
perform weighted fusion based on a weight of a fusion model according to the MLP predicted value, the XGBoost predicted value and a true value to obtain a slope stability;
determine whether the slope stability exceeds a predetermined threshold; and
send a warning signal indicating an instability state of a slope to external devices in response to the stability monitoring module determining that the slope stability exceeds the predetermined threshold.

8. A computer device, comprising: a memory, a processor and a computer program stored in the memory and executable on the processor, wherein the processor executes the computer program to implement the slope stability prediction method according to claim 1.

9. A non-transitory computer-readable storage medium, wherein the computer-readable storage medium stores a computer program, and the computer program implements the slope stability prediction method according to claim 1 when executed by a processor.

10. The computer device according to claim 8, wherein the mine slope stability influencing factors specifically comprise: a slope angle, a unit weight, a cohesion, a pore pressure coefficient, an internal friction angle and a slope height.

11. The computer device according to claim 8, wherein the MLP prediction model is specifically determined as follows:
constructing an original MLP model and initializing a weight and a bias of the original MLP model; and
optimizing an initialized weight and an initialized bias of the original MLP model with the Tent-VSSA according to sample data to obtain the MLP prediction model, the sample data being true mine slope stability influencing factors and corresponding true slope stabilities.

12. The computer device according to claim 8, wherein the XGBoost prediction model is specifically determined as follows:
constructing an original XGBoost model and determining an objective function of the original XGBoost model;
solving the objective function with a simplified Taylor expansion equation and a decision tree, and determining hyperparameters of the original XGBoost model; and
optimizing the hyperparameters of the original XGBoost model with the Tent-VSSA according to sample data to obtain the XGBoost prediction model, the sample data being true mine slope stability influencing factors and corresponding true slope stabilities.

13. The computer device according to claim 8, wherein the weight of the fusion model is specifically determined as follows:
performing prediction with the MLP prediction model according to true mine slope stability influencing factors to obtain a first predicted value;
performing prediction with the XGBoost prediction model according to the true mine slope stability influencing factors to obtain a second predicted value; and
determining the weight of the fusion model with an error reciprocal method according to the first predicted value, the second predicted value and a true slope stability.

14. The computer device according to claim 8, wherein Cauchy mutation perturbation is used to perform fused mutation on the Tent-VSSA.

15. The non-transitory computer-readable storage medium according to claim 9, wherein the mine slope stability influencing factors specifically comprise: a slope angle, a unit weight, a cohesion, a pore pressure coefficient, an internal friction angle and a slope height.

16. The non-transitory computer-readable storage medium according to claim 9, wherein the MLP prediction model is specifically determined as follows:
constructing an original MLP model and initializing a weight and a bias of the original MLP model; and
optimizing an initialized weight and an initialized bias of the original MLP model with the Tent-VSSA according to sample data to obtain the MLP prediction model, the sample data being true mine slope stability influencing factors and corresponding true slope stabilities.

17. The non-transitory computer-readable storage medium according to claim 9, wherein the XGBoost prediction model is specifically determined as follows:
constructing an original XGBoost model and determining an objective function of the original XGBoost model;
solving the objective function with a simplified Taylor expansion equation and a decision tree, and determining hyperparameters of the original XGBoost model; and
optimizing the hyperparameters of the original XGBoost model with the Tent-VSSA according to sample data to obtain the XGBoost prediction model, the sample data being true mine slope stability influencing factors and corresponding true slope stabilities.

18. The non-transitory computer-readable storage medium according to claim 9, wherein the weight of the fusion model is specifically determined as follows:
performing prediction with the MLP prediction model according to true mine slope stability influencing factors to obtain a first predicted value;
performing prediction with the XGBoost prediction model according to the true mine slope stability influencing factors to obtain a second predicted value; and
determining the weight of the fusion model with an error reciprocal method according to the first predicted value, the second predicted value and a true slope stability.

19. The non-transitory computer-readable storage medium according to claim 9, wherein Cauchy mutation perturbation is used to perform fused mutation on the Tent-VSSA.
